(19) United States
(12) Patent Application Publication
(10) Pub. No.: US 2005/0096913 A1
(43) Pub. Date: May 5, 2005

(54) Automatic clarification of commands in a conversational natural language understanding system

(76) Inventors: Daniel Mark Coffman, Bethel, CT (US); Jan Kleindienst, Nove Straseci (CZ); Ganesh N. Ramaswamy, Ossining, NY (US)

Correspondence Address: KEUSEY, TUTUNJIAN & BITETTO, P.C., 14 VANDERVENTER AVENUE, SUITE 128, PORT WASHINGTON, NY, 11050, US

(21) Appl. No.: 10/701,784

(22) Filed: Nov. 5, 2003

(51) Int. Cl. G10L 11/00

(52) U.S. Cl. 704/275

(57) ABSTRACT

A system and method for recognizing commands in natural language includes a speech recognizer for decoding language and semantic information in utterances provided by a user. A dialog manager provides a hierarchical ordering of handlers, each handler being trained to be responsive to decoded utterances. The dialog manager manages arbitration between the handlers to determine a winning handler for an utterance and decodes the command in accordance with the winning handler.

### BACKGROUND

1. Field

The exemplary embodiments disclosed herein relate to operation of a conversational computer system with multiple applications, and more, particularly to methods and systems for automatic clarification of commands in a conversational natural language understanding system.

2. Description of the Related Art

Conversational systems permit a user to employ natural communications techniques, or gestures, to interact with a computer device or system. Such a gesture may be, for example, the pressing of a button, the typing of text, or the speaking of a sentence. Such a system relies on a natural language understanding facility to interpret the meaning of the gesture and a dialog management capability to supply a response. In concert, these will be sufficient if the user supplies a gesture, which is complete by itself. Often, however, the user's gesture will be incomplete, unclear or ambiguous. If the system is to be considered truly conversational, it must be able to understand such gestures, as well.

Ambiguities may arise from three different sources. The first cause of ambiguity is that a gesture may be very general, possibly applying to several different aspects of the conversation. This becomes increasingly likely as more and more applications are operative simultaneously. Thus, if the user were to say “Go on to the next one” it is more than likely that several applications could respond to such a command. The user's intended target application was clear to him, however, and must be discovered by the conversational system without merely returning a question to the user requesting clarification, such as “Did you mean your calendar or you inbox?” Such questions quickly become annoying from human interlocutors and even more so from machines.

A second cause of ambiguity is that the user naturally assumes that the system will be able to remember certain aspects of the conversation even when these pertain to different applications. For example, if the user asks “Do I have anything scheduled on Tuesday with Mary?” he will not be surprised if the system needs clarification of the type “Do you mean Mary Smith or Mary Jones?”. If the user then poses the request “Send a note to her saying I will be away that day” he will expect that the system will be able to remember that the person in question is the Mary referred to earlier, even though the first use of the name was within a calendar application and the second a mail composition application.

A third cause of ambiguity is that all recognition systems are prone to occasional error. A user may speak unclearly, the environment may be noisy, or the user may use a word unknown to the recognition system. Further, natural language parsing systems incur errors of their own by their very nature: they permit the user to say whatever he wishes, but this freedom comes at the cost of some mistakes in understanding.

### SUMMARY

In all of the above-stated cases, the ambiguities need to be detected and then resolved in as natural a fashion as possible. This increases the user's acceptance of the system and decreases the time the user devotes to learning how to use it. Further, the mechanism for clarifying these ambiguities should be as automatic as possible for the ease of the system developer.

A system and method for recognizing and clarifying commands includes an automatic speech recognizer for decoding spoken utterances and a natural language processing facility for extracting the semantic content of the decoded speech. A dialog manager participates in the conversation by providing a hierarchically organized set of handlers. Each handler is designed to be responsive to a set of utterances so analyzed. The dialog manager manages arbitration among the handlers to determine a winning handler for an utterance and processes this utterance in accordance with the winning handler.

A system and method for recognizing commands in natural language includes a speech recognizer for decoding language and semantic information in utterances provided by a user. A dialog manager provides a hierarchical ordering of handlers, each handler being trained to be responsive to decoded utterances. The dialog manager manages arbitration between the handlers to determine a winning handler for an utterance and decodes the command in accordance with the winning handler.

These and other objects, features and advantages of the present disclosure will become apparent from the following detailed description of illustrative embodiments thereof, which is to be read in connection with the accompanying drawings.

### BRIEF DESCRIPTION OF DRAWINGS

The exemplary embodiments will be described in detail in the following description of preferred embodiments with reference to the following figures wherein:

FIG. 1 is a block diagram of an illustrative system for recognizing commands in natural language in accordance with an illustrative embodiment;

FIG. 2 is a block diagram showing hierarchical relationships between handlers in accordance with an illustrative embodiment;

FIG. 3 is a block/flow diagram showing and arbitration method in accordance with an illustrative embodiment; and

FIG. 4 is a block diagram showing a database used in resolving unresolved utterances in accordance with an illustrative embodiment.

### DETAILED DESCRIPTION OF PREFERRED EMBODIMENTS

Aspects of the present disclosure relate to construction of a computer system with the ability to participate in a conversation with the user. Such systems preferably employ a natural language understanding facility to interpret the user's gestures and a dialog management capability to supply a response. In concert, these aspects will provide sufficient information when a user supplies a gesture, which is complete by itself. The user's input will often, however, be ambiguous or unclear.

After a user's gesture, which is assumed from now on to be a spoken utterance, for illustrative purposes, has been processed by a natural language understanding (NLU) system, the result is a semantic parse. This encapsulates all information that may be gleaned from the utterance itself. For example, if the user says “I would like to see a flight from Boston to Denver”, a properly devised NLU system will identify Boston and Denver as cities, and further, that the city of departure is Boston and of arrival is Denver.

Frequently, the user will speak in a manner in which ambiguities arise of a type that is not easily clarified by a NLU system alone. For example, if the user says “I'll take the first one”, the NLU system can only be expected to recognize that a choice was being made and the relevant item was the first one. Matters become even more confused if the user says something along the lines of “I don't want to do that”. Here, the best the NLU system can do is to recognize that some action was being negated.

The NLU system may detect that the utterance given to the system for processing is incoherent, or incomplete. This will be so if the speech recognizer has been unable to decode the complete utterance without error, or if the user has said something outside of the domain of understanding of the NLU system. In this case, the NLU system will glean as much information as it can from the utterance and mark the result as being in need of clarification.

The ambiguities are preferably resolved through a twofold process. First, the semantic parse of the user's utterance is presented to each component, or handler, of the dialog management system. These are devised in such a way that they are aware of the types of utterances they may correctly interpret. Through an arbitration scheme, these decide among themselves, which is the correct target of the utterance. If no clear winner emerges, a tie-breaking algorithm comes into play.

Second, the contents of all parses and the results of all clarifications are kept in a specially designed database. Items in the database are referenced by their temporal order of entry into the database and their ontological classification or classifications. When the winner of the arbitration phase detects that one or more items within the received parse are incomplete or ambiguous, the winner may look within the database for an item providing resolution.

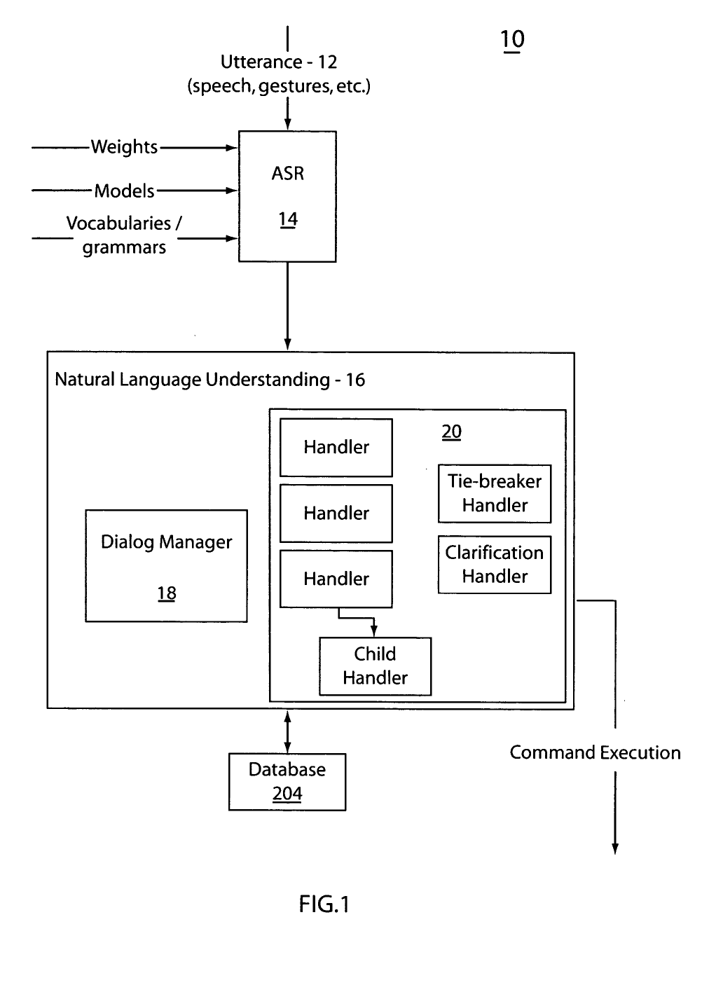

It should be understood that the elements shown in the FIGS. may be implemented in various forms of hardware, software or combinations thereof. Preferably, these elements are implemented in software on one or more appropriately programmed general-purpose digital computers having a processor and memory and input/output interfaces. Referring now to the drawings in which like numerals represent the same or similar elements and initially to FIG. 1, a block diagram showing a hierarchical system with handlers employed to arbitrate to determine a command is illustratively shown.

A user of a conversational system 10 provides an utterance 12, which is rendered as text by an automatic speech recognition (ASR) engine 14 and parsed into semantic components by an NLU system 16 (see e.g., Epstein, M., Papineni, K., Roukos, S., Ward, T., and Della Pietra, S., “Statistical Natural Language Understanding Using Hidden Clumpings”, IEEE ICASSP Proceedings, Vol. 1, pp 176-179, May 1996, incorporated herein by reference). Language models, vocabulary and any finite state grammars used by the ASR engine may be modified on an utterance-by-utterance basis. Similarly, the weights used by the NLU system when processing the rendered text by also be adjusted (see. e.g., Coffman, D. M., Gopalakrishnan, P. S., Kleindienst, J., and Ramaswamy, G. N., in “Method and Apparatus for Dynamic Modification of Command Weights in a Natural Language Understanding System”, assigned to IBM Corporation, U.S. patent application Ser. No. 10/654,205, filed on Sep. 3, 2003, and incorporated herein by reference.

The next component in the conversational system to come into play is the dialog management (DM) system 18. This is divided into a set 20 of small handlers (which include child handlers, tie-breaker handlers, clarification handlers, etc.), one each for a particular task or sub task. The entirety of the handlers 20 share a common view of the state of the interaction with the user, this is in spite of the fact that their tasks may be related to different applications, and they may be provided by several different vendors. This shared state comprises information not only about the current state of the interaction, but also of its history. Further, each of these handlers in set 20 is in one of two states: enabled, or disabled.

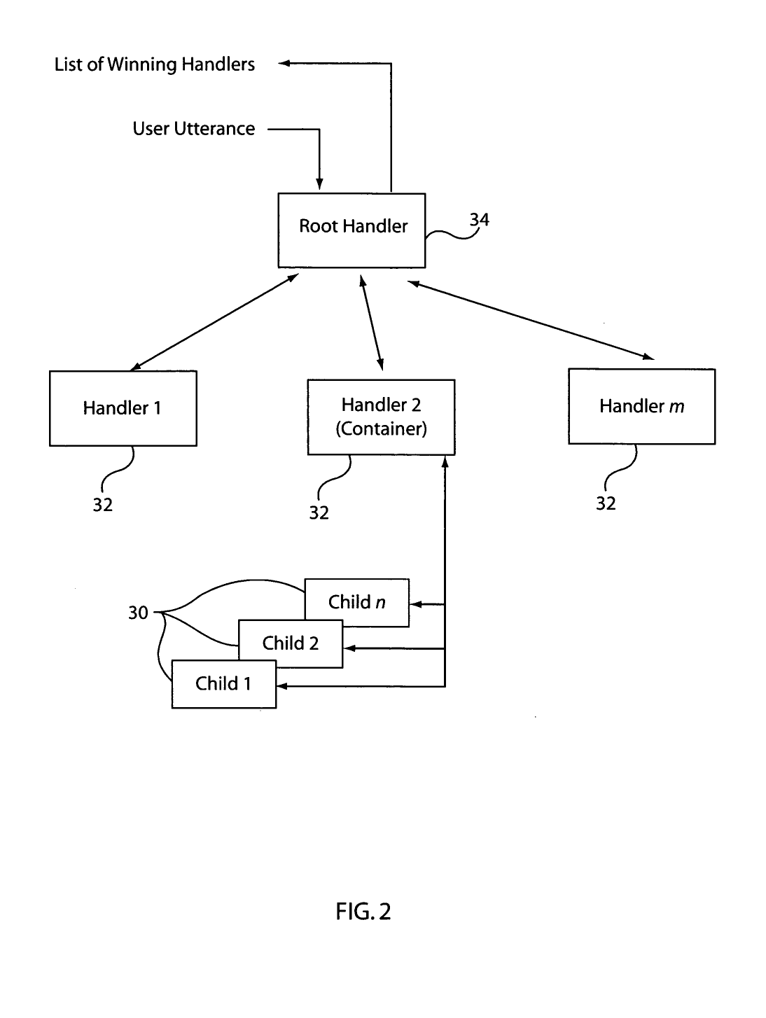

The user's utterance in its parsed representation is passed to the DM system 18. The handlers 20 decide among themselves what the intended target is by comparing features in the utterance to content stored in each handler to determine a highest score (which may include weighting and other score modification techniques, which may be known in the art). The handlers 20 are organized into a hierarchy as illustratively shown in FIG. 2. A database 204 is included to provide additional information in determining a winning handler for execution of commands.

Referring to FIG. 2, if a handler is created dynamically during an earlier stage of the conversation, the handler may be a child of a handler (e.g., child 30 of handler 32, which is serving as a container). For example, if the user orders several different items, each item may be under the control of a dynamically created handler all of which in turn are collected under a container handler (e.g., handler 2). The utterance is delivered to a root handler 34 in the hierarchy and subsequently to all nodes (30, 32, 34) of the hierarchy. Only nodes, which are enabled engage in the arbitration to follow unless they are containers (e.g., handler 2, in this example), with children. Container handlers (handler 2) pass the utterance onto their children 30 and collate their responses, even if they themselves are disabled. The structure shown in FIG. 2 is illustrative of a single example, a plurality of handles in various stages of a hierarchy are contemplated. For example, each child handler 30 may have many levels of handlers below it.

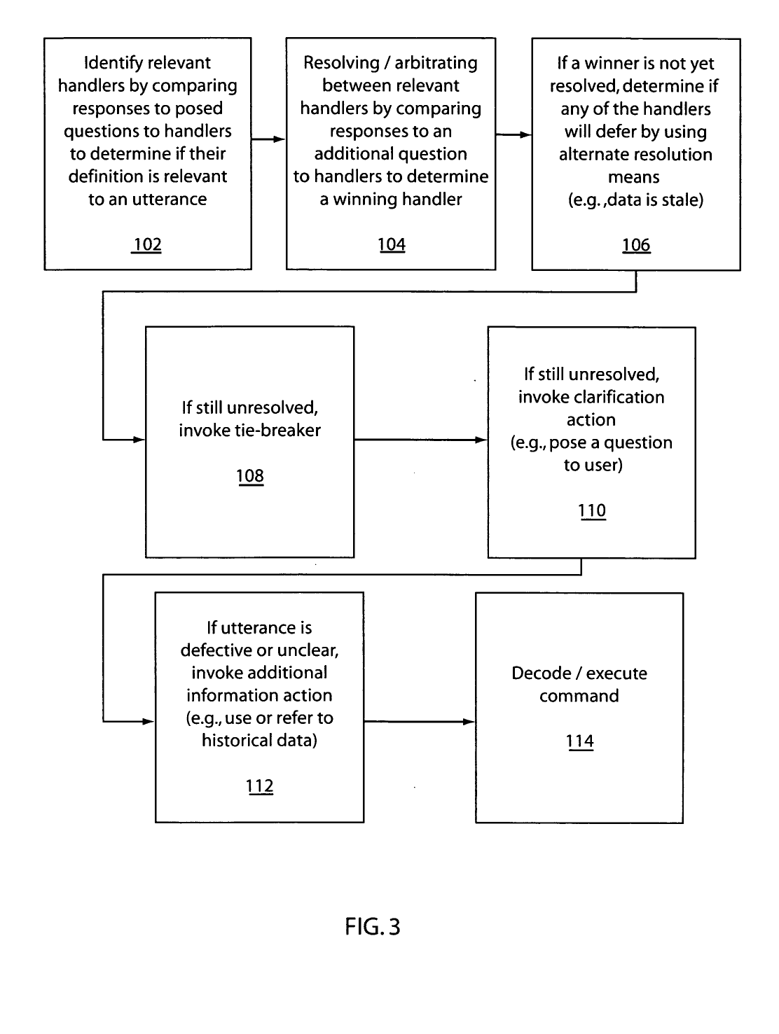

Referring to FIG. 3, arbitration proceeds in several phases, the goal of each being to identify a unique handler for the utterance. If such a unique handler is isolated, the arbitration ceases. If no handler at all is located, the arbitration fails. If more than one succeeds at any phase, the subset of successful handlers is taken to the next level of arbitration.

In block 102, a first stage of arbitration may be completely automated. A question of the form “Do you understand this utterance?” is posed to each handler and each enabled handler responds in the affirmative or the negative. Each handler, in its definition, is provided with a list of utterances it may understand. Since the utterance as represented here, is a semantic parse, such a list of utterances is actually a list of concepts and may be defined quite concisely. Thus, a handler for travel will understand the concepts of departure and arrival cities, dates and times whereas a handler for electronic mail may understand recipient and address.

In block 104, if two or more handlers respond that they understand an utterance, during the next phase of arbitration, each of these is posed an additional question of the form “Did you expect this?” Their responses are again binary. They will respond in the affirmative if the utterance is a possible response to a question the handlers have posed through some means, either audible or graphical. The handlers will respond in the negative if the utterance is understood but unsolicited. In general, these responses may be generated automatically. The handler need only remember, through the use of some short-term mechanism, that it had indeed posed a question.

If two or more handlers still express interest in the utterance, one further question may be posed of the form “Will you defer?” in block 106. A handler will respond in the affirmative if it had previously posed a question, but that this was sufficiently far in the past that the question may safely be considered “stale”. The threshold time for such a determination may be specific to a particular handler, or may be set globally for all handlers. The handler will, on the other hand, respond in the negative if the question it posed was more recent than this threshold time. Other data or schemes such as historic data may be employed to resolve the contention as well.

If these arbitration steps fail to isolate a unique handler for an utterance, a tie-breaking handler is invoked in block 108 to pose a clarifying question to the user. This special handler is of a type, which will be used, in two additional contexts, to be described below. A tie-breaking handler is similar to other handlers in that it is specific for a particular class of utterances. It is selected from among all other tie-breaking handlers through a process identical to the first phase of arbitration described above. Tie-breaking handlers participate in all phases of the arbitration; they are constructed never to win the second phase, or third phase or arbitration. Further, the successful tie-breaking handler has access to the list of handlers, which have already passed all three previous phases of arbitration. This list and the utterance are stored for future use. Given the ambiguous utterance, this list of competing handlers, and the current state of the system, it is the duty of the tie-breaking handler to pose a clarifying question to the user. This question is tailored to be as intelligent and helpful as possible, implying in some manner the source of the ambiguity. For example, were the users to say “No, cancel that”, the system might respond “Cancel your stock purchase or hotel reservation?” The tie-breaking handler formulates this question in such a way that the tie-breaking handler will win the arbitration for handling the user's answer, since all active handlers will be in contention for it, as always. It may do this through the use of a specially tailored grammar or through a special set of weights for the NLU system.

After the tie-breaking handler is presented with a response, the tie-breaking handler uses this to select the correct handler from the list of previous winners stored previously, and then passes the previous utterance to this winning handler. This handler then processes this originally ambiguous utterance exactly as if it had won the arbitration in the first place.

A similar case occurs if no handler wins the first phase of arbitration. This may occur if the user invokes a concept managed by a handler currently disabled, or if the concept refers to an application not currently installed. In both cases, this situation may have been prevented by adjusting the weights of the NLU system to prevent the concept from being identified in the first place. This may not always be possible. If such a circumstance arises, a dialog repair handler may be used to present a reasonable set of choices to the user in block 110. It is selected just as the tie-breaking handler, and is similar in nature, except that it performs its job with only the ambiguous utterance, and the current state of the system to guide it. The response it formulates is either merely informative, or may propose an action.

For example, if the user says “Find the most recent note from Mary Smith”, the clarification handler may respond “Your mailbox is not open”. However, it would be more helpful if it were to respond “Your mailbox is not open. Should I open it for you?” As in the case of a tie-breaking handler, the clarification handler, in this latter case, stores the original utterance, and waits for the user's response, again ensuring that the clarification handler will receive it. If the response is affirmative, the clarification handler completes the suggested action, and then delivers the previously stored utterance to the system again for arbitration, the assumption being that this time arbitration will succeed in finding a suitable handler.

A third situation occurs when the NLU system detects that an utterance is defective, or unclear, and needs additional information to be useful in block 112. In this case, the utterance, after being marked as defective by the NLU system, is submitted for arbitration just like any other utterance. However, a clarification handler will identify the utterance as something it understands. The correct clarification handler is selected from among all such handlers by arbitration. This clarification handler examines the information provided in the utterance, and attempts to identify what is missing or defective. The clarification handler attempts to supply missing pieces by sifting through the history of interaction as described below.

Similarly, the clarification handler attempts to correct defective pieces by examining the current state of the system. In most cases, the clarification handler will pose a confirming question to the user of the type “Did you mean to say . . . ?” As before, it stores the original utterance and ensures that it will receive the response. If this response is in the affirmative, the clarification handler repairs the original utterance, removes the mark indicating that the utterance was defective, and resubmits the utterance for arbitration.

Another situation for ambiguity relates to when the user's utterance refers to some previous facet of his interaction with the system. In this case, the speech recognizer is assumed to: correctly decode his speech, the NLU system correctly to parse it, and the arbitration scheme correctly to identify the appropriate handler. However, some component of the utterance may still turn out to be ambiguous when the component is examined by the handler. For example, if the user says “Send a message to her”, this may appear completely unambiguous until the handler assigned to such a mail task attempts to resolve the name of the person in question. What is not desired, indeed not even generally acceptable, is for the system to respond always with a clarifying question. Rather, the system examines the contents of a special database, a database of previous utterances and their complete resolution.

Once a winning handler has been determined, the command or commands are decoded and/or executed in accordance with the winning handler in block 114.

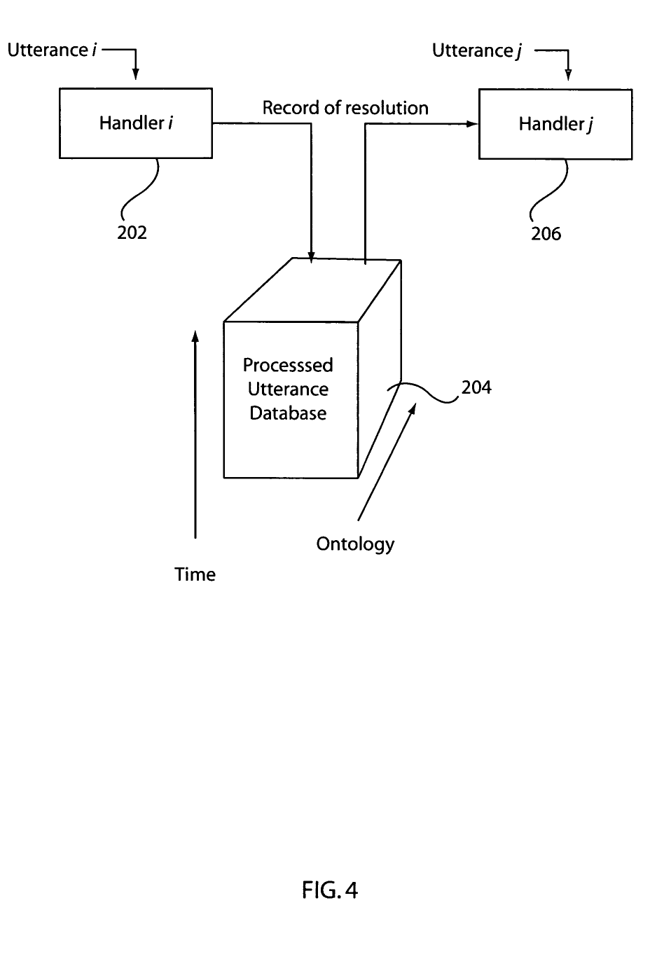

Referring to FIG. 4, each time a user's utterance (i) is processed by a handler 202, it stores the results in a database 204. If ambiguity resolution is needed in the course of this processing, the intermediate steps and their final results are stored as well. The database 204 is constructed so that its contents may be searched by their ontology, and well as temporal ordering. Other search criteria may also be employed. In the current example, suppose the user had said “Do I have a meeting on Tuesday with Mary?” If the result of this query was affirmative, and that the “Mary” in question was deduced to be “Mary Jones”, an entry would have been placed in the database with the source “Mary”, the resolution “Mary Jones” and the ontological classifications say “woman” and “colleague”. If the result were negative, an entry would have been placed in the database 204 with source of “Mary”, a null resolution and classification of “woman”. Now, when the user says “Send a message to her”, the handler 202 may request the most recent database entry of classification “woman”. If the resulting record includes a successful resolution, this may safely be used as the appropriate value of “her”. If there was no such resolution, the retrieved source may still be used as the basis of resolution, exactly as if the user had said “Send a message to Mary”.

Only in the case where no corresponding record in the database may be found does the handler need to pose an unintelligent question of the type “Whom do you mean?”. Handler j 206 is the resolved handler based on information stored in database 204.

Having described preferred embodiments for automatic clarification of commands in a conversational natural language understanding system (which are intended to be illustrative and not limiting), it is noted that modifications and variations can be made by persons skilled in the art in light of the above teachings. It is therefore to be understood that changes may be made in the particular embodiments disclosed which are within the scope and spirit of the invention as outlined by the appended claims. Having thus described the details and particularity required by the patent laws, what is claimed and desired protected by Letters Patent is set forth in the appended claims.

1. A method for recognizing commands in natural language, comprising the steps of:
comparing an utterance to a plurality of handlers;
identifying a winning handler for decoding a command from the utterance, wherein the winning handler is identified by arbitration between handlers; and
decoding the command in accordance with the winning handler.

2. The method as recited in claim 1, wherein the step of identifying includes resolving ties in the arbitration between handlers by employing a tie-breaker handler.

3. The method as recited in claim 2, wherein the tie-breaker handler poses a question to a user to determine the winning handler.

4. The method as recited in claim 1, wherein the handlers include an enabled or a disabled state and further comprising the step of presenting the utterance to enabled handlers.

5. The method as recited in claim 4, further comprising the step of submitting the utterance to disabled container handlers to ensure submission of the utterance to child handlers.

6. The method as recited in claim 1, further comprising the step of submitting unresolved utterances to winning handlers of a previous utterance for decoding.

7. The method as recited in claim 1, further comprising the step of maintaining a database of a history of handler selections.

8. The method as recited in claim 7, wherein the history includes time based ordering and ontological information.

9. The method as recited in claim 7, further comprising the step of resolving unresolved utterances by employing information stored in the database.

10. The method as recited in claim 1, wherein the step of decoding further includes executing a command in accordance with the winning handler, responsive to the utterance.

11. A program storage device readable by machine, tangibly embodying a program of instructions executable by the machine to perform method step for recognizing commands in natural language as recited in claim 1.

12. A method for recognizing commands in natural language, comprising the steps of:
providing a plurality of handlers trained to be responsive to given utterances;
arbitrating against other handlers to determine a winning handler for an utterance; and
decoding the command in accordance with the winning handler.

13. The method as recited in claim 12, further comprising the step of resolving ties in the arbitration between handlers by employing a tie-breaker handler.

14. The method as recited in claim 13, wherein the tie-breaker handler poses a question to a user to determine the winning handler.

15. The method as recited in claim 12, wherein the handlers include an enabled or a disabled state and further comprising the step of presenting the utterance to enabled handlers.

16. The method as recited in claim 15, further comprising the step of submitting the utterance to disabled container handlers to ensure submission of the utterance to child handlers.

17. The method as recited in claim 12, further comprising the step of submitting unresolved utterances to winning handlers of a previous utterance for decoding.

18. The method as recited in claim 12, further comprising the step of maintaining a database of a history of handler selections.

19. The method as recited in claim 18, wherein the history includes time based ordering and ontological information.

20. The method as recited in claim 18, further comprising the step of resolving unresolved utterances by employing information stored in the database.

21. The method as recited in claim 12, further comprising the step of executing a command in accordance with the winning handler, responsive to the utterance.

22. A program storage device readable by machine, tangibly embodying a program of instructions executable by the machine to perform method step for recognizing commands in natural language as recited in claim 12.

23. A system for recognizing commands in natural language, comprising:
a speech recognizer for decoding language and semantic information in utterances provided by a user; and
a dialog manager comprising a hierarchical ordering of handlers, each handler being trained to be responsive to decoded utterances wherein the dialog manager manages arbitration between the handlers to determine a winning handler for an utterance and decodes the command in accordance with the winning handler.

24. The system as recited in claim 23, wherein the handlers include at least one tie-breaker handler for resolving ties in the arbitration between handlers.

25. The system as recited in claim 24, wherein the tie-breaker handler poses a question to a user to determine the winning handler.

26. The system as recited in claim 23, wherein the handlers include an enabled or a disabled state and the utterance is presented to enabled handlers or disabled container handlers with child handlers.

27. The system as recited in claim 23, further comprising a database for storing a history of handler activities.

28. The system as recited in claim 27, wherein the history includes time based ordering and ontological information.

29. The system as recited in claim 27, further comprising at least one clarification handler, which resolves unresolved utterances by employing information stored in the database.
